(19) United States
(12) Patent Application Publication
(10) Pub. No.: US 2026/0170313 A1
(43) Pub. Date: Jun. 18, 2026

(54) CHANNEL MODELING USING GENERATIVE ARTIFICIAL INTELLIGENCE

(71) Applicant: DeepSig Inc., Arlington, VA (US)

(72) Inventors: Wan Liu, Arlington, VA (US); Nitin Nair, Arlington, VA (US); Johnathan Corgan, Arlington, VA (US); Tom Tsou, Arlington, VA (US); Rajib Bhattacharjea, Arlington, VA (US); Timothy James O’Shea, Arlington, VA (US)

(21) Appl. No.: 19/424,496

(22) Filed: Dec. 18, 2025

Related U.S. Application Data
(60) Provisional application No. 63/735,861, filed on Dec. 18, 2024.

(51) Int. Cl. G06N 3/0475; G06N 3/08

(52) U.S. Cl. CPC G06N 3/0475; G06N 3/08

(57) ABSTRACT

Methods, systems, and apparatus, including computer programs encoded on computer storage media, for training a neural receiver using output from a trained flow model. In some implementations, a system obtained signal data from one or more antenna elements. The system trains a generative machine learning model using the obtained signal data to generate synthetic data that approximates the obtained signal data. The system uses the generative machine learning model to generate the synthetic data that approximates the obtained signal data. The system trains a neural receiver to perform a signal processing function using the generated synthetic data. The system deploys the trained neural receiver over a communication network.

### CROSS-REFERENCE TO RELATED APPLICATION

This application claims the benefit of U.S. Provisional Application No. 63/735,861, filed on Dec. 18, 2024, which is incorporated herein by reference in its entirety.

### TECHNICAL FIELD

This specification relates to wireless channel modeling using generative artificial intelligence tools, and specifically, training normalizing flow models for neural networks in signal processing chains.

### BACKGROUND

In wireless communication systems, e.g., based on European Telecommunications Standards Institute (ETSI) Third Generation Partnership Project (3GPP) 4th Generation Long Term Enhancement (4G LTE), 5th Generation New Radio (5G-NR), 6th Generation (6G) networks, IEEE 802.11 (Wi-Fi) networks, and/or Bluetooth networks, the frequencies, bandwidths, and timeslots can be pre-coordinated. Both the transmitter and receiver can have bands allocated to them and be provided with information indicating where to find a signal in the spectrum. This allows the receiver to focus on specific frequency bands and specific protocols for signal detection.

Machine learning models are increasingly used in data processing systems that perform various signal processing functions in the wireless communication systems. However, despite recent advances, existing machine learning models suffer from several limitations that reduce their overall reliability, efficiently, and deployment in the wireless communication systems.

### SUMMARY

The techniques described in the specification generally relate to leveraging artificial intelligence tools to model wireless channels for training and deploying neural receivers. These techniques involve processing radio signal information and training one or more neural network models using the radio signal information to perform one or more specific functions, such as one or more radio signal processing functions. In this context, a neural network is an example of a machine learning (ML) model. A system can train one or more neural network models to produce synthetic data or approximations of the input data. Once the neural network models are sufficiently trained, the synthetic data output from the neural network models can be used to subsequently train one or more neural receivers to perform one or more radio signal processing functions. The radio signal processing functions can include, for example, demodulation, bit synchronization, forward error correction, or channel estimation, to name a few examples. Once the neural receivers are sufficiently trained to perform the signal processing functions, the system can deploy the trained neural network models and/or the trained neural receivers over a wireless communication network.

In some implementations, a neural receiver can be integrated into a signal processing chain to perform the respective function. The neural receiver can include one or more trainable neural networks. These trainable neural networks can be trained using various data types, such as data from different geographical environments, simulated data, or other data types. However, training the neural networks on real time recorded data may be unwieldly when the size of the training data requires training that lasts for longer than desired. For example, the real time recorded data can result in large datasets in ranges of gigabytes (GB), terabytes (TBs), or larger. This information may require a large storage footprint, may be difficult to transmit over different geographical regions, and/or may be difficult to access certain portions of the data without expensive computer equipment.

Moreover, the efficacy of the neural receivers depends on the availability of representative training data, e.g., synthetic data, that matches to or attempts to approximate real world channel conditions. Accordingly, to reduce the amount of time required to train these neural networks and to improve the efficacy of trained neural receivers, the system can transform the real time recorded data into synthetic or approximated data that accurately represents the recorded data while being significantly smaller and retaining the integrity of the input data. Specifically, the system can train ML models such as generative machine learning models or generative artificial intelligence (AI) models, to produce synthetic data that models the wireless channels from the real time recorded data. In this context, the terms generative machine learning model and generative AI (genAI) models are used to refer to the same ML models or the same underlying models, and are used interchangeably.

Once trained, a generative AI model can produce synthetic data that approximates the site specific geographical data. One advantage of generating training data in this fashion is that the size of the generated synthetic data is significantly smaller than the size of the recorded site specific geographical data. As a result, the amount of time required to train the neural networks is significantly reduced while the integrity of the trained neural network is retained. Once the neural network is sufficiently trained, the neural network can perform a respective signal processing function as if the neural network were trained on the recorded site specific geographical data. In this manner, the trained neural networks can be incorporated in a wireless communication system with the knowledge of geographic site specific information, reducing the amount of time required to train and improving the entire training process of the neural networks.

The neural receivers described herein, which are trained on the output of the trained generative AI models, perform comparably to those neural receivers trained on real world channel measurements. Moreover, the neural receivers trained on the output of the trained generative AI models can achieve improved bit error rate and/or block error rate performance compared to baseline methods. These techniques provide a scalable and site-specific solution for training neural receivers to perform a specific signal processing function.

In one general aspect, a method is performed by one or more computers, such as a server. The method includes: obtaining signal data from one or more antenna elements; training a generative machine learning model using the obtained signal data to generate synthetic data that approximates the obtained signal data; using the generative machine learning model to generate the synthetic data that approximates the obtained signal data; training a neural receiver to perform a signal processing function using the generated synthetic data; and deploying the trained neural receiver over a communication network.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the generated synthetic data represents a percentage of the obtained signal data while retaining characteristics of the obtained signal data.

In some implementations, retaining characteristics of the obtained signal data includes the generated synthetic data retaining a target percentage characteristic of the obtained signal data.

In some implementations, obtaining signal data from one or more antenna elements includes obtaining downlink signal data from the one or more antenna elements.

In some implementations, the downlink signal data includes orthogonal frequency division multiplexing (OFDM) data.

In some implementations, training the generative machine learning model using the obtained signal data to generate the synthetic data that approximates the obtained signal data includes: generating a doppler-delay representation of the OFDM data; and training the generative machine learning model using a subset of coefficients from the doppler-delay representation.

In some implementations, training the generative machine learning model using the obtained signal data to generate the synthetic data that approximates the obtained signal data includes: generating delay data by applying an inverse discrete Fourier transform along a frequency dimension of the OFDM data; generating Doppler data by applying a discrete Fourier transform along a time dimension of the OFDM data; generating an output representation of the obtained signal data using the delay data and the Doppler data; extracting a subset of coefficients from the output representation of the obtained signal data; and training the machine learning model using the extracted subset of coefficients from the output representation.

In some implementations, extracting a subset of coefficients from the output representation of the obtained signal data includes extracting the subset of coefficients from the output representation by truncating the output representation of the obtained signal around a mean value and a zero Doppler value.

In some implementations, the extracted subset of coefficients from the output representation of the obtained signal represents a first target number for doppler bins and a second target number for delay bins, wherein the first target number is less than the second target number.

In some implementations, training a neural receiver to perform a signal processing function using the generated synthetic data includes: sampling one or more synthetic outputs from the trained generative machine learning model; providing the one or more synthetic outputs as input to the neural receiver; in response, generating a negative log likelihood using output from the neural receiver; and updating parameters of the trained neural receiver to perform the signal processing function by minimizing a loss function based on the negative log likelihood.

In some implementations, the signal processing function includes at least one of demodulation, forward error correction, bit synchronization, timing estimation, or channel estimation.

In some implementations, the method further includes pretraining the neural receiver on 5GNR-compliant PUSCH signals that have passed through a set of TDL channels.

In some implementations, the generative machine learning model includes a normalizing flow model that is configured to (i) generate the synthetic data and estimate a likelihood that the synthetic data approximates the obtained signal data.

In some implementations, deploying the trained neural receiver over a communication network includes transmitting, over a network, the trained neural receiver to at least one of a base station, a user equipment device, or a radio.

The subject matter described in this specification can be implemented in various embodiments and may result in one or more of the following advantages. In some implementations, the system can train a generative AI model to produce a synthetic representation of the input data. The synthetic representation of the input data may be a fraction in size of the input data, but provides a distinct advantage in that the generative AI model ensures the synthetic representation maintains characteristics representative of the input data. For example, the synthetic representation can include data that maintains time, frequency, delay, and doppler characteristics of the input data. The generative AI model can be trained to produce the synthetic representation that maintains characteristics of the input data to a desired target percentage, e.g., 80%, 90%, 99%, etc. In this manner, the generative AI model can generate an approximation or reduced representation of the input data that maintains the characteristics of the input data without losing its structural integrity.

Moreover, the system provides an advantage by reducing the overall memory footprint. Specifically, the trained generative AI model produces a synthetic representation that is a fraction of the size of the input data. For example, once sufficiently trained, the trained generative AI model and its output can correspond to a data file size of approximately 20 to 30 MB, to name a few representative sizes and ranges. This is significantly less than the size of the input data, which can range anywhere from tens to hundreds of gigabytes (GB) or more. As a result, the use of the trained generative AI model and its generated output offers a significant technological improvement by reducing its memory footprint.

Additionally, the generative AI model and the neural receiver can be jointly trained with site specific geographical data. The generative AI model can be trained to produce synthetic data that models a wireless channel of a corresponding geographic region. Afterwards, the neural receiver can be trained using the synthetic data that models the wireless channel of the corresponding geographic region. The trained generative AI model and/or the trained neural receiver can then be deployed to one or more different geographic regions. In this manner, the generative AI model is deployed to various devices for producing a wireless channel model which represents an approximation of the region corresponding to the input data or a geographic location of where the input data was recorded.

This joint training technique and deployment is beneficial for a multitude of reasons. For example, if an individual is located in an urban region and desires to model a wireless channel representative of a suburban or rural region, the individual can employ the trained generative artificial intelligence model in the urban region to produce the wireless channel representative of the suburban or rural region without having to travel to the same. Similarly, if the individual is located in a rural region and desires to model a wireless channel, the individual can employ the trained generative artificial intelligence model in the rural region to produce the wireless channel representative of the urban region without having to travel to the rural region. As a result, this site specific training enables individuals to have test beds for their specific components, e.g., neural receivers or other devices, without having to travel to a designated geographic region. Accordingly, this reduces the burden on the individual and provides a wireless model representative of any geographic region.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are block diagrams that illustrate examples of systems for training a generative artificial intelligence model and a neural receiver using signal data.

FIG. 2 illustrates an example driving map showing locations of captured cell specific reference signals.

FIG. 3 illustrates a double-additive coupling layer in a normalizing flow model.

FIG. 4 illustrates representations of measured channels and representations of trained generative artificial intelligence output in multiple domains.

FIG. 5 illustrates representations of doppler-delay domains in a recorded channel and a generated channel.

FIG. 6 is a flow chart of an example process for training a generative artificial intelligence model and a neural receiver.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

The disclosed techniques include training neural receivers with data output by trained generative artificial intelligence (AI) models. Neural receivers, which incorporate trainable neural networks into their signal processing chains, offer significant potential for site-specific modeling in wireless communications. However, the efficacy of neural receivers depends on the availability of representative training data that matches to or closely approximates real world channel conditions. The disclosed techniques leverage generative AI models, and specifically normalizing flow models, to model wireless channels for the evaluation of neural receivers. These neural receivers can operate, for example, in the 3G, 4G, 5G, 6G, and other wireless communication networks. By training the normalizing flow models on real world channel measurements, the disclosed techniques can generate synthetic channel data that realize or closely mimic site specific conditions.

The generative AI models or the normalizing flow models, for example, can serve as a compact alternative to large datasets, enabling efficient training and evaluation of neural receivers. The results demonstrate that neural receivers fine-tuned on data generated by the trained flow models can perform comparably to those normalizing flow models fine-tuned on measured data. For example, the trained normalizing flow models achieve superior bit error rate and block error rate performance compared to other baseline methods. As a result, this highlights the potential of generative AI based channel model for advancing next generation wireless systems by offering a scalable and site specific solution for enhancing communication algorithms with an overall reduced memory footprint. In some cases, future directions can include exploring advanced generative AI modeling techniques and conditional channel generation to develop digital twin models for wireless environments.

In some implementations, neural receivers are an emerging technology that can replace portions of a traditional receive signal processing chain with neural networks that utilize trainable weights. Using neural networks in this way enables site specific tuning of the receiver algorithm based on measured channel conditions for enhanced throughput and bit error rate. Additionally, the utilization of neural networks in this way has been used to demonstrate pilot free OFDM communications. Data driven training algorithms have can utilize tens of thousands of examples to train the neural receiver. The training data can include, for example, packets passed through a channel simulation and using capture of over-the-air (OTA) captures of cellular downlink signals.

In some cases, simulated data can be utilized in these workflows. However, the ability for the neural network models to generalize from simulated data to real world data is contingent upon how closely the conditions of the simulated data match the conditions of the real world conditions. Consequentially, training on real world data that or generated with knowledge of the real world channel conditions leads to models that improve their understanding and output of the real world test conditions.

As further described below, the disclosed techniques to the generalization issue include adapting the recent advances in generative AI to the problem associated with wireless channel simulation. Generative AI is a data driven methodology to learn an approximation of the statistical distribution of a dataset in such a way that random samples can be drawn from the learned distribution that are nearly indistinguishable, e.g., by a human, from the input distribution. This is the technology that powers large-language-model chat-bots such as ChatGPT and popular image generators such as DALL-E, Stable Diffusion, and Midjourney, to name a few examples.

One way in which these methods can be applied to wireless channel modeling is to train a generative AI model on measured channel data from a specific site. Then, the trained generative AI model can generate samples that credibly appear to be site-specific channel measurements. These outputs can then be used as a practically unlimited source of site-specific training data for a neural receiver, and also used to evaluate other wireless algorithms or system performance. Though this idea may at first seem overly complicated or circuitous, it is not without some concrete benefits.

If the size, e.g., measured in bytes, needed to store the generative AI model weights and graph is smaller than the dataset it was trained on, and the generated samples are approximately indistinguishable from the training dataset, then the generative AI model can be deployed to train and evaluate neural receiver algorithms without having to store the larger training data set. In some cases, a site specific generative AI model hub in which network operators can quickly download a trained generative AI model to train a receiver for a specific location or evaluate performance of their algorithms in site specific channel conditions. In such a model hub, there is value in small models that capture the richness of real-world channel conditions, but which can require a fraction of the bandwidth to deliver. Another concrete benefit of this approach is that channel realizations drawn from a generative AI model can provide a form of data augmentation of measured data. The samples drawn from the model are approximately in the same statistical distribution as that of the training data, and so random realizations drawn from the generative AI model are in a sense augmented examples from the training data.

The validity of training neural receivers on the output produced by the generative AI models trained on measured data hinges on understanding if the trained neural receiver performs similarly to one trained directly on the measured data. If the receiver performance is similar in both cases, then the generative AI model provides a good representation for a larger volume of training data.

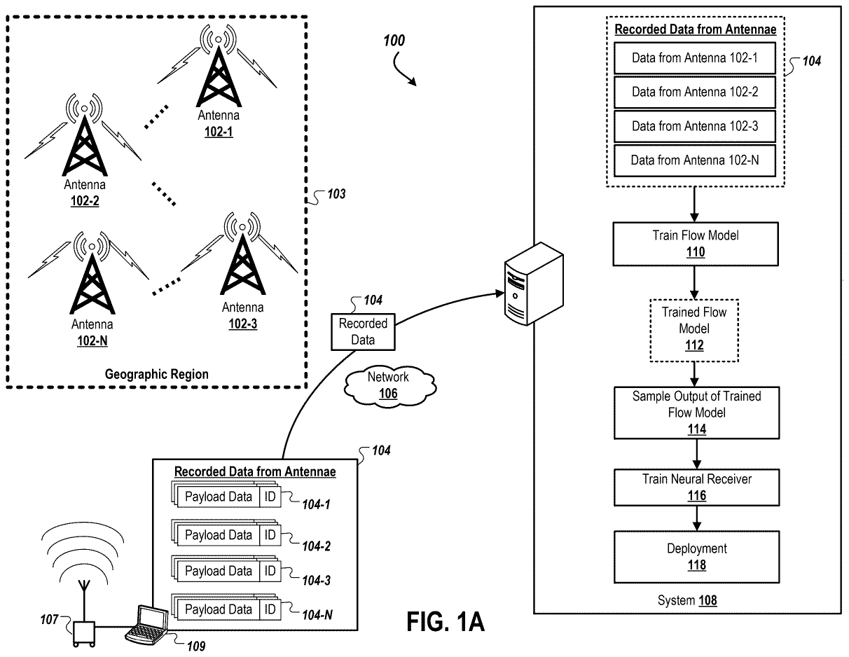

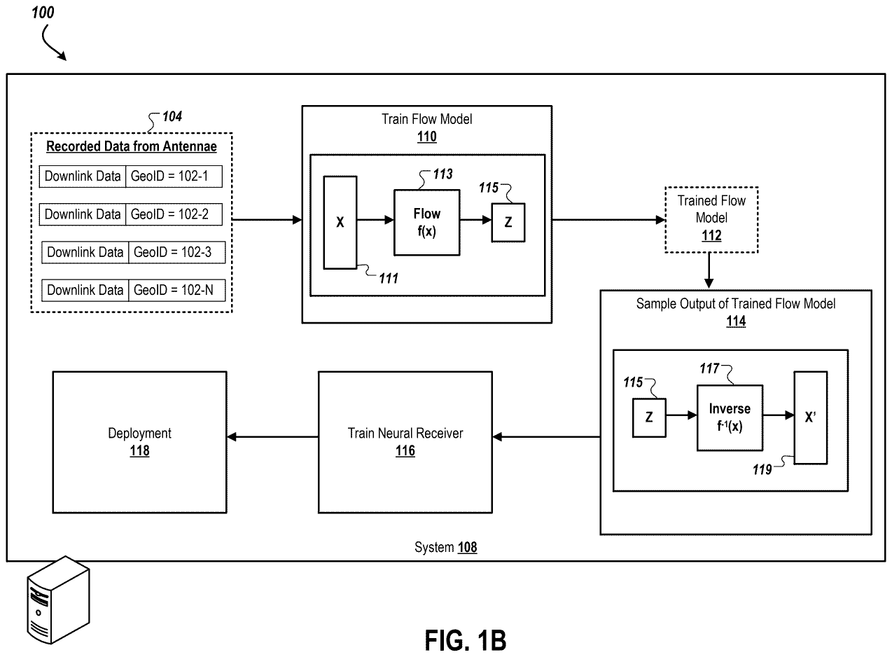

FIG. 1A is a block diagram that illustrates an example of system 100 for training a generative artificial intelligence model and a neural receiver using signal data. The system includes a computer system 108, one or more antennae 102-1 through 102-N (hereinafter “antennae 102”), an external computer device 109, a radio 107, and a network 106.

In some implementations, the radio 107 can capture one or more radio frequency (RF) signals from the antennae 102 in a geographic region 103. The geographic region 103 can include any geographic region that includes one or more antennae 102. For example, the geographic region 103 may refer to Arlington, Virginia and the antennae 102 can correspond to the antennae within the city of Arlington.

The one or more RF signals can include downlink signals that utilize orthogonal frequency division multiplexing (OFDM). In an OFDM system, a wideband channel is divided into multiple narrowband subcarriers, each of the subcarriers is independently modulated. These subcarriers are mathematically orthogonal, which provides for high spectral efficiency and robustness to multipath fading. An OFDM symbol is generally formed by a transmitter performing an inverse Fast Fourier Transform (IFFT) on a block of modulated subcarrier values, resulting in a time domain waveform that carries information across multiple frequency components.

In some implementations, the downlink OFDM frame can include both data resource elements and predefined resource or pilot elements. The pilot elements can include cell specific reference signals (CRS) embedded at predetermined time frequency positions with the OFDM resource grid. CRS values are generally known a-priori to both the transmitter and the receiver, and they can serve as pilot tones used by the receiver for various purposes, e.g., channel estimation, equalization, and other synchronization tasks. Because the CRS occupies fixed subcarriers and OFDM symbol indices, the receiver can identify these positions deterministically and extract the transmitted pilot values from the received OFDM symbols. The one or more RF signals can also include other signal components than OFDM.

In some implementations, the external computer device 109 can move through the geographic region 103 and record signal data. For example, the external computer device 109 may be attached to a vehicle, a person, a bicycle, or another component that allows for movement through the geographic region 103. While moving through the geographic region, the radio 107 can continuously or periodically record raw downlink RF signal from the one or more antennae 102. As mentioned, the recorded raw downlink RF signal data can include one or more OFDM based signals transmitted by a corresponding antenna, e.g., antenna 102-3. The radio 107 can record and process the recorded raw downlink RF signals by digitizing them through an analog-to-digital converter and store the OFDM signal in baseband for subsequent processing.

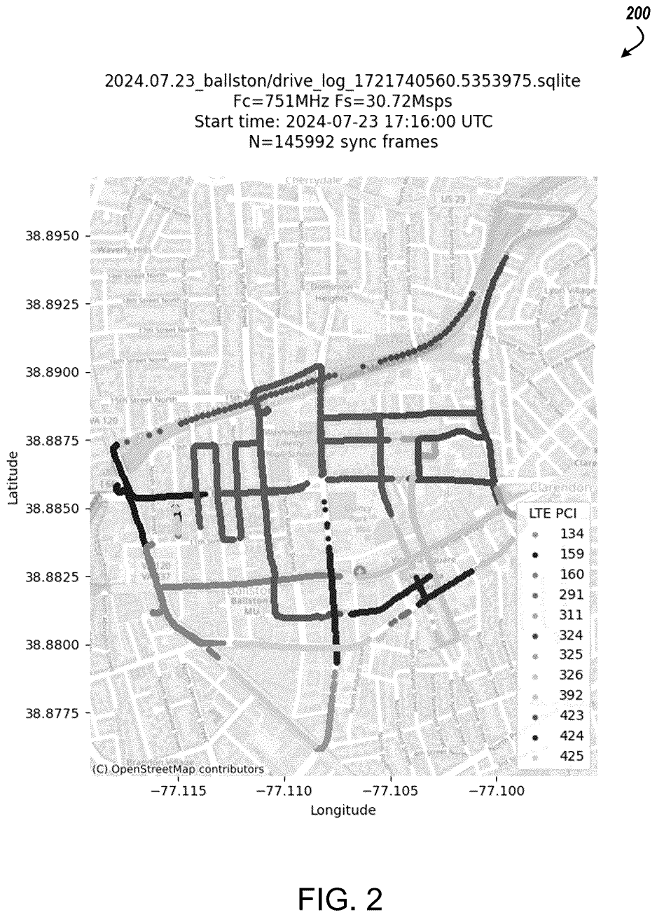

For example, the external computer device 109 and the radio 107 can be attached to a vehicle that moves through the geographic region 103. The dataset collected by the external computer device 109 and the radio 107 is represented with respect to FIG. 2, which illustrates a graphical representation 200 of an example driving map showing locations of captured cell specific reference signals. In particular, the graphical representation 200 illustrates a route taken by the vehicle with the external computer device 109 and the radio 107 periodically and/or continuously recording and capturing cell specific reference signals. The vehicle may move through geographic region 103 in typical driving speeds, between approximately 0 and 70 MPH. The data collection sets include 145,992 instances of channel measurements captured over a drive that lasted approximately 65 minutes. The captured channel measurements include data from 12 unique towers, as identified by the physical cell identity (PCI) number decoded from the downlink, which will be further described below. The size of the captured channel measurements is approximately 16-17 GB in size.

After storing the OFDM signal in baseband for subsequent processing, the external computer device 109 can perform one or more signal processing functions on the baseband OFDM signal for preparing the training of the generative AI models. In particular, the external computer device 109 can extract individual OFDM symbols from the baseband OFDM signal. To accomplish this, the external computer device 109 can perform standard OFDM processing techniques, e.g., timing synchronization, filtering, and automatic gain control, to name a few, in order to identify the boundaries of the OFDM symbols. In some implementations, the external computer device 109 can perform cyclic prefix (CP) detection to actively detect an OFDM symbol by aligning with a start of the OFDM symbol.

After the external computer device 109 identifies each OFDM symbol, the external computer device 109 can segment each OFDM symbol into a cyclic prefix portion and a useful data portion. The external computer device 109 can remove the cyclic prefix portion and transform the remaining useful data portion using a fast Fourier Transform (FFT). This operates generates the frequency domain subcarrier values that correspond to the individual resource elements (REs) that are the composite of each OFDM symbol.

The external computer device 109 can analyze the extracted OFDM symbols to identify pilot or reference elements, such as the cell-specific resource signals (CRS), demodulation reference signals (DRS), or another known sequence embedded at predefined or known frequency locations. By isolating and identifying each of these elements, the external computer device 109 can estimate the channel frequency response and can perform demodulation and decoding of the remaining subcarriers that carry downlink or control information.

For example, the external computer device 109 can determine the measured channel frequency response data using the obtained OFDM symbols. Specifically, the external computer device 109 can post process the least-squares estimate in the pilot positions using a Wiener filter, for example, to interpolate and extrapolate to the channel frequency response over all the REs in the OFDM signal grid. In some cases, an OFDM signal grid can include 600 REs for the case of 10 MHz LTE signals found in the continental US. The Wiener filter applied by the external computer device 109 include cut-off parameters that are 300 nanoseconds (ns) of delay spread and 100 Hz of Doppler spread. In some implementations, the Wiener filter can operate on one LTE subframe within the OFDM symbol. This means that the process can produce channel estimates that are at least 14 OFDM symbols long in time by 600 REs wife in frequency.

In some implementations, the external computer device 109 extracts the useful data from each OFDM signal. As illustrated in the example of the system 100, the external computer device 109 extracts useful data from each downlink OFDM signal and stores the useful data in memory. The useful data includes payload data and a corresponding physical cell identity (PCI) corresponding to the antenna that transmitted the recorded OFDM downlink data. For example, the recorded data 104-1 was transmitted by antenna 102-1, the recorded data 104-2 was transmitted by antenna 102-2, the recorded data 104-3 was transmitted by antenna 102-3, and the recorded data 104-N was transmitted by antenna 102-N.

In some implementations, the external computer device 109 can transmit the recorded data 104 to the computer system 108 over the network 106. The network 106 may include the Internet, Wi-Fi, Bluetooth, or another form of a communication network. The computer system 108 can receive the recorded data 104 and initiate the processes of training the generative artificial intelligence models and/or subsequently, the training of the neural receivers.

At 110, the computer system 108 can train the generative AI model using the recorded data from antennae 102. Generally, the recorded downlink data from the antennae 102 can be used to train the generative AI model, e.g., a normalizing flow model. In this case, the generative AI model can be trained to generate a synthetic representation of the recorded downlink data. The synthetic representation of the recorded downlink data can reflect a modeling of the channel of the geographic region 103.

The computer system 108 can process recorded data 104 to generate training inputs for the flow model. The training inputs can be, for example, 14 OFDM time slots by 600 REs wide, which is a time frequency representation. In some examples, the recorded data 104 samples can be processed to create frequency-domain subcarrier values, channel estimates, or pilot structures to name a few examples.

In some cases, a Fourier dual representation of the training inputs by applying an inverse discrete Fourier transform along the frequency dimension and a discrete Fourier transform along the time (OFDM symbol) dimension. This results in a delay Doppler representation. The delay Doppler representation shows information in the channel response clustered around a few coefficients near the mean delay and zero Doppler. Next, the computer system 108 can truncate the delay Doppler domain channel response to a first set of Doppler bins and a second set of delay bins. In some examples, the first set of Doppler bins can range from 5 to 15. In some examples, the second set of delay bins can range from 30 to 80 delay bins. For example, the computer system 108 can truncate the delay Doppler domain channel response to 6 Doppler bins and 40 delay bins. The computer system 108 can then train the normalizing flow model on the reduced dimensionality representation.

In order to train the normalizing flow model, the computer system 108 can specify a target latent distribution. The target latent distribution can be, for example, a Gaussian or normal distribution. Other distribution types are also possible, such as a Laplacian distribution and a logistic distribution. Then, the process of training the flow model can be framed as a standard maximum-likelihood estimation problem. This process seeks to modify parameters to estimate weights of the MLP layers, and the parameters of the latent distribution, e.g., the mean and covariance matrix of the Gaussian. Training proceeds using standard deep learning methods to minimize the negative log likelihood using the AdamW optimizer to update the parameter estimates once per mini-batch of the training data. Each mini-batch can include 500 training examples, for instance. During training, the initial learning rate corresponds to approximate 0.003, with an exponential learning rate scheduler that reduces the learning rate by a factor of 0.94 each training epoch, which includes 292 steps.

During training of the flow model, the flow model can learn an invertible mapping between the recorded OFDM data and a latent space that represents the channel model, e.g., channel impairments, channel propagation characteristics, or other underlying features. Because flow models provide a reversible transformation, the system can learn to both encode received waveforms into latent waveforms and decode latent waveforms back into waveform representations. This enables specific functions of downstream tasks, e.g., channel estimation, signal reconstruction or receiver analysis.

In some implementations, at 110, the flow model can be trained on OFDM signals recorded from a single antenna. Training on data collected from a particular antenna, e.g., antenna 102-3, enables the flow model to learn antenna specific propagation patterns, multipath characteristics associated with that particular antenna, interference sources, or other geographic site specific effects. By training a flow model to perform according to characteristics of a single antenna, the computer system 108 can generate a flow model that is configured to generate synthetic representations for a particular antenna, which may be beneficial to a particular user or users.

In some implementations, the flow model can be trained using data collected from multiple antennae distributed throughout the geographic region 103. The computer system 108 can train the flow model on data from diverse antenna positions and their corresponding characteristics, which allows for the flow model to better represent the geographic region. Specifically, the flow model can capture broader spatial variations in channel conditions, including differences in path loss, multipath, shadowing, and scattering across the geographic region 103. This multi-antenna training approach can improve the flow model's ability to better represent the channel conditions across the geographic region 103 as a whole.

In some implementations, the computer system 108 can train the flow model to generate synthetic representations of the input data. The synthetic representations can include approximations of the input data and can preserve a desired portion of the statistical characteristics of the original input signal. During training, the computer system 108 can define a target percentage or a target threshold indicating the number of characteristics to be preserved in the synthesized output when produced by the trained flow model. The statistical characteristics can include, for example, time characteristics, frequency characteristics, delay characteristics, and doppler characteristics, each contributing to the modeling of the recorded channel.

In order for the computer system 108 to train the flow model to achieve the target percentage or the target threshold indicating the number of characteristics to be preserved, the computer system 108 can train the flow model with an objective function that constrains the generation of the synthetic representation to maintain a specified proportion of features derived from the recorded input data. The target percentage or target threshold can correspond to metrics, for example, such as the subcarriers preserved characteristics, e.g., amplitude or phase characteristics, percentage of the channel response recorded, an amount of power spectral density of the recorded channel across the frequency bins, or the number of symbols to include from the recorded signal data. In some implementations, these metrics can be computed across one individual OFDM symbol or across different and multiple OFDM symbols.

The training procedure can include comparing the output synthetic representation generated by the flow model with the original input data and then adjusting the parameters of the trained flow model to satisfy the target threshold or target percentage requirement. For example, the loss function during training may measure the deviation and penalize deviations from the desired target percentage. As a result, the flow model can learn a tradeoff between the amount of data to preserve and the amount of synthetic data to generate.

Turning to FIG. 1B, the computer system 108 can provide the recorded data 104 as input to the flow model 113 in order to train the flow model 113. In some implementations, the computer system 108 can train a flow model 113 in a normalizing direction. The normalizing direction enables the flow model 113 to learn an invertible transformation between a predefined base distribution and the empirical distribution represented by the recorded data 104. For example, as illustrated in FIG. 1B, the computer system 108 can specify a normal (Gaussian) distribution as the base distribution, and the training process can adjust the parameters of the flow model 113 so that the forward transformation maps the recorded data into the base distribution. Similarly, the inverse transformation can map the samples from the base distribution back into the data domain. In some implementations, the resulting data distribution can take the form of a multivariate normal distribution in a high dimensional latent space.

The input data 111 is used to train the flow model 113, represented as a flow operator f(x). The flow operator is constructed to be exactly invertible, rather than only approximately invertible. This can be achieved using neural networks or deep learning architectures that enforce structural constraints, such as coupling layers or invertible factors. Unlike conventional encoder and decoder models, which often discard information and form approximate only inverse mappings, the trained flow model maintains a one-to-one mapping between the input space and the latent space, which ensures that each transformed sample has a precise inverse.

Because the flow model 113 is invertible and implemented using a neural network like architecture, the computer system 108 can determine the parameters of both the flow transformation and the latent distribution using a maximum likelihood framework. Each training sample xᵢ is assigned a likelihood defined by:

$${p}_{z} ( f ( {x}_{i} ; ϕ ) ; θ ) \qquad ( 1 )$$

Equation 1 represents the probability density output of the transformed sample under the base distribution for a given set of parameters. The likelihood computation of the entire training dataset would require the product of all the likelihoods per training example if they were all independent using the following equation (2):

$$L ( ϕ , θ ) = {\prod }_{i} {p}_{z} ( f ( {x}_{i} ; ϕ ) ; θ ) \qquad ( 2 )$$

The transformation learned by the flow model can adjust the probabilities associated with the training data as the samples are mapped from the input domain into the latent distribution domain. With the maximum likelihood framework applied in equation 2, each training example can receive a likelihood based on how the transformed sample aligns with the base latent distribution. As a result, the likelihood reflects how well the current parameter settings explain or characterize the observed data when expressed in the latent space. As the training of the flow model progresses, the computer system 108 can adjust the flow model 113's parameters so that the transformed samples increasingly conform to the target latent distribution.

In order to determine the correct parameters for the flow model, the computer system 108 can execute one or more processes that maximizes the likelihood of the recorded data set under the model. This is achieved by minimizing the—log L(φ, θ), where φ represents the parameters of the flow transformation and θ represents that parameters of the base latent distribution. The computer system 108 may perform one or more processes, e.g., stochastic gradient descent (SGD) or one of the variants, such as Adam or RMSProp, to iteratively update the parameters. During this process, the model can move towards parameter values that make the transformed samples more probable under the chosen latent distribution, which improves the model output.

Once the flow model 112 has been sufficiently trained, then in block 114, the computer system 108 can sample the model output to generate synthetic samples that mimic the statistical characteristics of the recorded input data. To generate a sample, the computer system 108 can first sample or retrieve a latent vector z 115 from the base distribution p_{z}(z). In some implementations, the base distribution is parametrized by θ, such as the mean and covariance matrix in the case of a normal or Gaussian distribution. Sampling from the latent distribution may involve a random number generator or other sampling mechanism.

After obtaining the latent vector z 115, the computer system 108 can apply the inverse flow operator 117, denoted as f⁻¹(z; φ), which maps the latent sample back into the data domain. The inverse flow operator 117 can use the learned parameters φ to reconstruct a corresponding synthetic output. The resulting output x′ 119 refers to a generated data instance that exhibits statistical properties similar to those of the recorded data on which the flow model 112 was originally trained. As a result, the trained flow model enables the system to generate synthetic realistic representations of OFDM or RF related data representative of the channel without requiring the original physical signals.

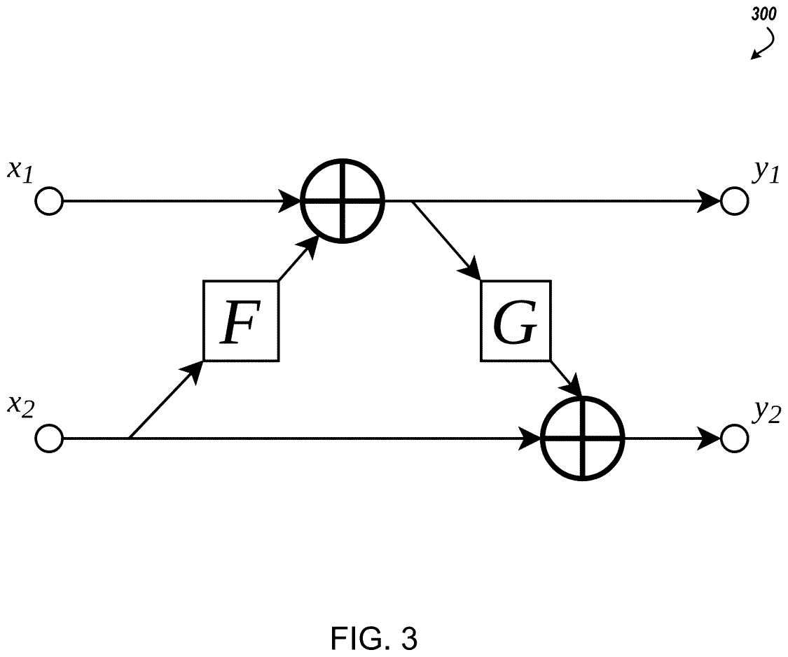

Turning to FIG. 3, the flow operator from the flow model 112 uses multiple neural networks. FIG. 3 illustrates a double-additive coupling layer in a normalizing flow model. In particular, FIG. 3 illustrates a portion of a graphical model 300 in which F and G are neural networks, x₁ and x₂ are splitting the larger input dimension in half. In the illustrated example of FIG. 3, the flow operator can employ two neural networks, F and G, that operate on different portions of the input vector x₁ and x₂. For example, the networks F and G can include compositions of a layer norm, linear layer, GELU activation, the sequence of layer normalization and a single layer of an MLP, e.g., a linear layer followed by an activation, GELU. In some examples, the flow model comprises three such double-additive coupling layers in sequence.

Each neural network can perform a transformation on one subset of the data while conditioning on the other subset. For example, the neural network F may process x₁ while using information from x₂, and the neural network G may process x₂ while using information derived from x₁. These conditional relationships allow the overall flow operator to learn complex dependencies across the input dimensions.

In some cases, the neural networks F and G may correspond to coupling layers, masked networks, autoregressive modules, or other deep-learning constructs designed to maintain a one to one mapping between the input and output. The example of FIG. 3 illustrates a double-additive coupling layer. By alternating the roles of F and G across multiple stages or layers, the flow model can progressively transform the input data into a latent representation consistent with the base distribution. Likewise, the inverse operator applies the same components in reverse order to reconstruct the data from sampled latent vectors.

Returning to FIG. 1A, when the flow model is trained in this manner, the trained flow model 112 can generate synthetic representations that are consistent with real world propagation while limiting the produced data set according to the target threshold. This ensures that the output synthetic data still represents or approximates the input recorded data, maintains an output size file that is manageable, and reduces the amount of time required to train the neural receivers. The target threshold or target percentage can be adjusted on an as-needed basis.

In some implementations, the computer system 108 can designate the flow model as sufficiently trained once the target threshold is met for a desired input. In some implementations, the computer system 108 can designate the flow model as sufficiently trained after a certain number of training cycles or epochs has passed. As illustrated in the example of system 100, the computer system 108 outputs a trained flow model 112.

After training the flow model, at 116, the computer system 108 can sample the output of the trained flow model at 114 and apply those samples to train the neural receiver. Prior to training the neural receiver with the output from the trained flow model, the computer system 108 can pre-train the neural receiver on standardized 5G New Radio (5GNR)-compliant Physical Uplink Shared Channel (PUSCH) signals. The 5GNR-compliant PUSCH signals can then be propagated through a set of simulated Tapped Delay Line (TDL) channels that emulate realistic multipath, fading, Doppler, and delay spread conditions encountered in practical environments. The resulting channel impaired PUSCH waveforms act as pre-training data for the neural receiver, and enabling the neural receiver to learn proper signal processing behaviors prior to exposure of synthetic data output by the trained flow model for a specific radio signal processing function.

In some implementations, the computer system 108 can train the neural receiver to perform a specific radio signal processing function. As mentioned above, first the neural receiver is pre-trained on synthetic channel realizations and fine-tuned on measured data from the measurements. Training slots are generated according to the 5G NR specification using both data and pilot symbols, with slots of a fixed modulation and coding scheme (MCS) and random transport-block (TB) bit contents. The training of the neural receiver involves the use of a channel simulator, which can apply a multiple input multiple output (MIMO) channel impulse response to the slot, using a channel realization that was viewed over the air during measurement, and Gaussian nose is added at a specific relative noise power to achieve a desired signal-to-noise ratio (SNR).

The selection of which channels are used for training and testing can vary depending on how “site-specific” the desired evaluation process is. For example, it may be desirable to test a single PCI's locality performance using only samples from the PCI, e.g., a single antenna, or it may be of interest to sample only channel response from a region of portion of a geographic region more broadly. Finally, the slots are received by the neural receiver, which performs the functions of channel estimation, equalization, demodulation, and demapping required to generate soft-bit output corresponding to log-likelihoods of the original data which can be decoded. The bit error rate (BER) and block error rate (BLER) are measured at different SNR operating points for the receiver while using random data and samples of real channel responses in a BLER sweep.

A “passing” BLER, such as 10% is chosen as a target, corresponding to a BLER target level, which might be used by a 5G MAC scheduler, and an intersection is interpolated between measured BLER values to determine a “passing” SNR for the BLER sweep. This can be repeated for any number of receiver algorithms to obtain corresponding sensitivity performance for passing SNR, and relative SNRs can be compared in order to inspect relative sensitivity of different receiver algorithms. Neural receivers that can change a target BLER, e.g., 10% error rate, at lower SNRs are considered better because they can successfully operate in noisier channels, or equivalently, at longer ranges between transmitter and receiver.

For training the neural receiver, the difference between the decoded bits and the known transmitted bits is used to define a loss function. Then, a standard variant of gradient descent optimization is used to update the weights of the neural receiver to reduce the value of the loss function in a process called training. The baseline neural receiver can correspond to a neural receiver that is trained against channel realizations drawn from TDL scenarios, and compare that against a fine-tuned neural receiver that is pre-trained on TDL scenarios but can also undergo fine-tuning. In some examples, the computer system 108 can employ different TDL scenarios, such as using a mix of TDL-B and TDL-C channels with delay spreads ranging from 10 to 600 nanoseconds and Doppler ranging from 20-400 Hz.

After the flow model training and evaluation in 114 and 116, the computer system 108 can fine tune and evaluate the neural receiver. In some cases, the computer system 108 can evaluate the trained neural receiver using samples drawn from the trained flow model output in 116 and using the full set of recorded data 104. The computer system 108 can evaluate several variants of the trained neural receiver.

In some examples, the computer system 108 can evaluate a trained neural receiver that was not trained on site-specific fine tuning. This particular neural receiver was trained only on TDL and had no awareness of any site specific channel conditions. This particular neural receiver, labeled as the “Neural Rx,” serves as a baseline neural receiver.

In some examples, the computer system 108 can evaluate another receiver that was fine-tuned on recorded channel measurements. The receiver's performance serves as an upper bound on the gains to be had from site specific fine tuning of a neural receiver.

In some examples, the computer system 108 can evaluate a different receiver that was fine-tuned on channel realizations drawn from a flow model trained on the recorded channel measurements. If the flow model samples are close in distribution to the channel measurements, then this different receiver should perform similarly to the neural receiver trained directly on the channel data.

In some implementations, for the “perfect noise and channel estimation” receiver, this receiver's performance is an absolute upper bound on performance. The receiver receives not only the signal that results from passing the 5G PUSCH signal through a simulated channel, but the receiver also directly receives the true channel matrix and noise state the simulator used to generate the output. The receiver uses this information directly, instead of estimating it, to perform the optimal MMSE receiver algorithm.

The MMSE receiver provides a conventional signal processing baseline. The MMSE receiver employs MMSE equalization similar to the “perfect noise and channel estimation” algorithm, but differs in how it estimates the denoised and interpolated channel matrix. Specifically, the MMSE receiver uses a Wiener filter applied to a least squares channel estimate, combined with the pilot residual method for noise estimation.

Evaluation of the neural receiver is in terms of the BER and BLER, which are the basic metrics of how well a digital communications receiver is performing. A measured BER is the fraction of bits that are not correctly received over a measurement interval; the BLER is the fraction of blocks that the forward error correction (FEC) coding scheme cannot recover over a measurement interval. This work using 5G NR compliant waveforms for evaluation so the FEC coding schemes and transport block sizes for BLER calculations are each found in the relevant specification.

In some implementations, the computer system 108 can perform a BLER sweep on each of the evaluated. The BLER sweep is a test in which a receiver, e.g., neural or otherwise, operates on a large number of 5G NR compliant slots that pass through a channel conditions drawn from some distribution, e.g., measured, TDL simulations, or drawn from a trained flow model, and at various levels of signal-to-noise ratio (SNR), and the BLER is plotted for the receiver as a function of the SNR. Each BLER sweep also has an associated modulation and coding scheme (MCS) that specifies the FEC code rate and the order of the modulation constellation on each subcarrier. The techniques described below evaluate BLER sweeps across a range of MCS values as well. Finally, the SNR at 10% BLER is a metric that can be used to compare receivers operating in the same conditions. If a receiver can achieve the threshold 10% BLER at a lower SNR, then the receiver is a more sensitive receiver that can operate in more harsh noise conditions.

At 118, the computer system 108 can deploy the trained flow model and the trained neural receiver over a wireless network for subsequent use. In some implementations, the trained flow model or the trained neural receiver can be deployed. In some implementations, the trained flow model may deployed over a wireless network to a network node, base station, edge server, or user device to generate synthetic channel realizations, perform channel prediction, or support adaptive signal-processing functions. The trained flow model can enable generating synthetic channel realizations, for example, of a particular geographic region that the flow model was previously trained on.

Likewise, the trained neural receiver can be deployed at a radio unit, user equipment, or baseband processing system to improve demodulation, channel estimation, or decoding performance under practical wireless conditions. In some implementations, the computer system 108 can deploy both the trained flow model and the trained neural receiver to operate together in a distributed manner across multiple network elements. This enables the wireless network to utilize learned channel characteristics, enhance link reliability, and adapt to changing propagation environments.

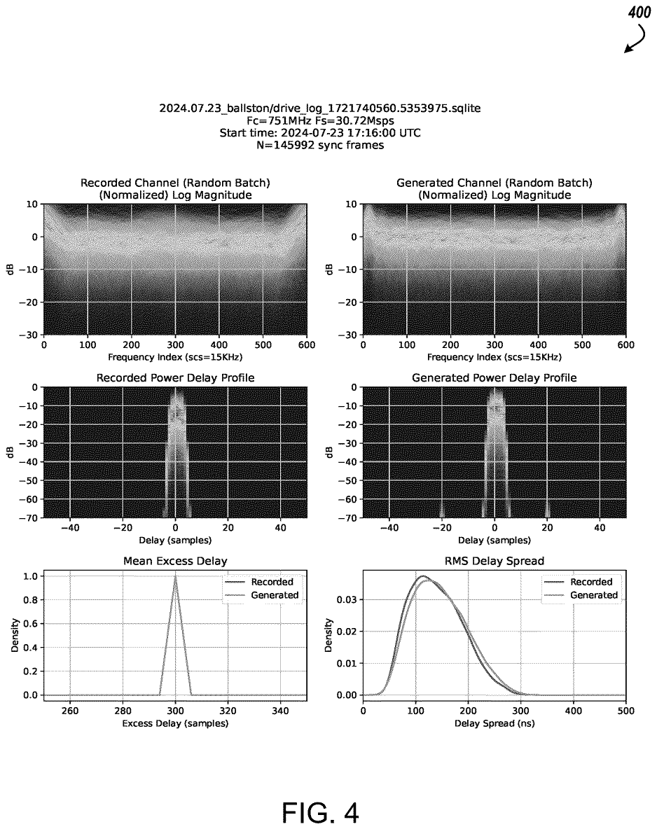

FIG. 4 is a graphical interface 400 that illustrates representations of measured channels and representations of trained generative artificial intelligence output in multiple domains. In particular, the graphical interface 400 provides a high level comparison between the measured wireless channels and the channels generated by the trained flow model. The figures show graphical representations in both frequency and the time domain on the first two rows. Additionally, the graphical interface 400 illustrates a comparison of two standard channel modeling metrics of mean-excess delay and delay-spread compared between the measured and generated channels realizations on the bottom row.

The top row of subfigures in the graphical interface 400 illustrates the frequency domain magnitude responses across the 600 REs included in the measurement. To visualize the distribution of responses rather than the individual responses, each frequency response is superimposed on a common set of axes, and then resulting plot is rendered using a two-dimensional histogram. In this case, the color at each point reflects how frequently a frequency response passes through that region of the plot. The top left plot illustrates the 2D histogram for the measured data, while the top right plot illustrates the corresponding histogram obtained from samples generated by the trained flow model in the generative direction. The two plots illustrate and exhibit strong similarity, indicating that the generated frequency responses closely approximate the measured responses. Minor deviations appear between the lower and upper RE indices, but overall, the frequency responses suggest that the flow model can accurately reproduce the statistical structure of the observed and measured frequency domain channels.

The middle row of subfigures applies the same 2D-histogram visualization technique to the delay-domain representation of the channels. The middle left panel corresponds to the measured channel, and the middle right panel corresponds to the channel synthesized by the trained flow model.

As in the frequency-domain comparison, the delay-domain histograms for the measured and generated data are highly similar, with small differences occurring around a delay of approximately 20 samples. These components exhibit more than 55 dB attenuation relative to the dominant delay components, meaning they contribute very little power. The close agreement across the main regions of energy indicates that the generated channels accurately reflect the delay-spread characteristics present in the measured dataset.

The bottom row of the graphical interface 400 depicts the mean excess delay and RMS delay spread metrics for both the measured channels and the generated channels. These summary statistics further confirm the consistency between the two datasets. The close alignment of these metrics demonstrates that the trained flow model is able to reproduce not only the qualitative structure of the channels but also the quantitative channel characteristics.

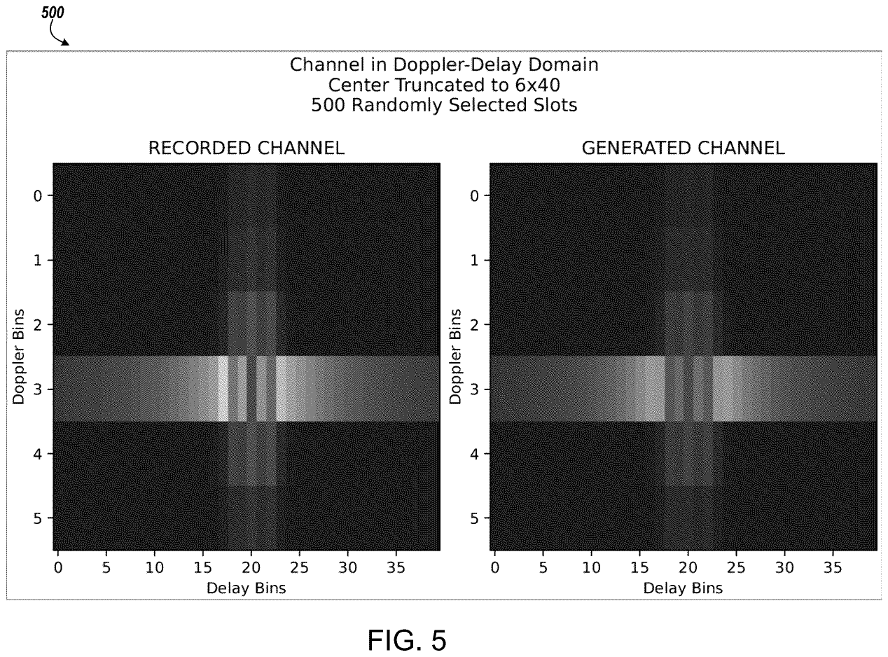

FIG. 5 is a graphical interface 500 that illustrates representations of doppler-delay domains in a recorded channel and a generated channel. In particular, the graphical interface 400 focuses on the central region of the delay Doppler domain, specifically, a 40-by-6 block of Doppler and delay bins. To construct this comparison, the computer system 108 can select 500 random channel realizations from the measured dataset and 500 channel realizations generated by the trained flow model. For each set, the magnitudes of the delay Doppler response are summed or averaged across all 500 realizations. This produces two aggregated plots-one plot for the measured data and another plot for the generated synthetic data. Other ranges of Doppler and delay bins are also possible.

In both the measured and generated cases, the magnitude distributions over the central Doppler bins and delay bins exhibit a high degree of similarity. The similarity provides a qualitative confirmation that the trained flow model outputs match the input data distribution, and namely, that the trained flow model captures the key statistical characteristics of the recorded wireless channels and reproduces the same characteristics in the synthetic data.

The previous section demonstrates that the trained flow model produces channel responses that broadly match the input training data in 1) the shape of the frequency responses, 2) impulse responses, 3) mean delay, 4) delay spread, and 5) delay-Doppler spectrum. Using samples generated from the flow model and the measured data on a downstream task is another method to see how closely the flow model matches the measured data. To this end, the neural receiver was trained on both the measured data samples and on realizations drawn from the flow model.

As a result, the techniques of system 100 includes site specific analysis of neural receivers based on channel measurements by direct training on the site-specific data or by training on the output of a generative AI model that approximates the site-specific data. This leads to neural receivers that outperform a conventional baseline such as MMSE, and do so over a range of MCS values in the 5G specification. The techniques also demonstrate the method of normalizing flows to this domain of wireless channel modeling. The trained flow models have also been demonstrated to qualitatively match the expected features of the training data with respect to time, frequency, delay, and Doppler characteristics, and the channel realizations resulting from sampling the trained flow model can be used for training and evaluating 5G system performance.

The trained flow model weights and computation graph occupy 20 to 30 MB on disk, whereas the trained flow model is capable of credibly recreating samples that look like they came from a dataset that is over 16 GB in size, for example, resulting in an effective lossy compression ratio of about 800×. This has tremendous potential to aid in the effective deployment of these models to testbeds where current and future generation algorithms are being developed, tested, and evaluated. These techniques provide a future where simplified TDL models are not the standard against which algorithms and system performance is measured in the laboratory, but instead site-specific generative AI models become the interchange format for storing measurement datasets against which algorithms can be developed and performance can be evaluated.

Future research directions include comprehensive studies of alternative generative AI formulations for this problem space, as well as exploring the breadth of alternatives within the flow modeling world. The described method is based on some of the earliest work in normalizing flows, and advances have been made in flow models which have yet to be applied to the problem of channel modeling. The idea of conditional channel generation, in which the latent space of a generative AI model can be conditioned on other factors, e.g., specific location of the receiver in the environment, can lead to new kinds of generative AI digital twins for wireless applications.

These kinds of channel models can be trained on real world measurements and be able to infer the channel for specific physical locations in the vicinity of the measurements. For example, a simulated pedestrian can traverse the trained digital twin model, and a sequence of the channel realizations that can be expected can be drawn from the generative AI model, aiding the further development of next generation algorithms for beam forming, and channel estimation and equalization.

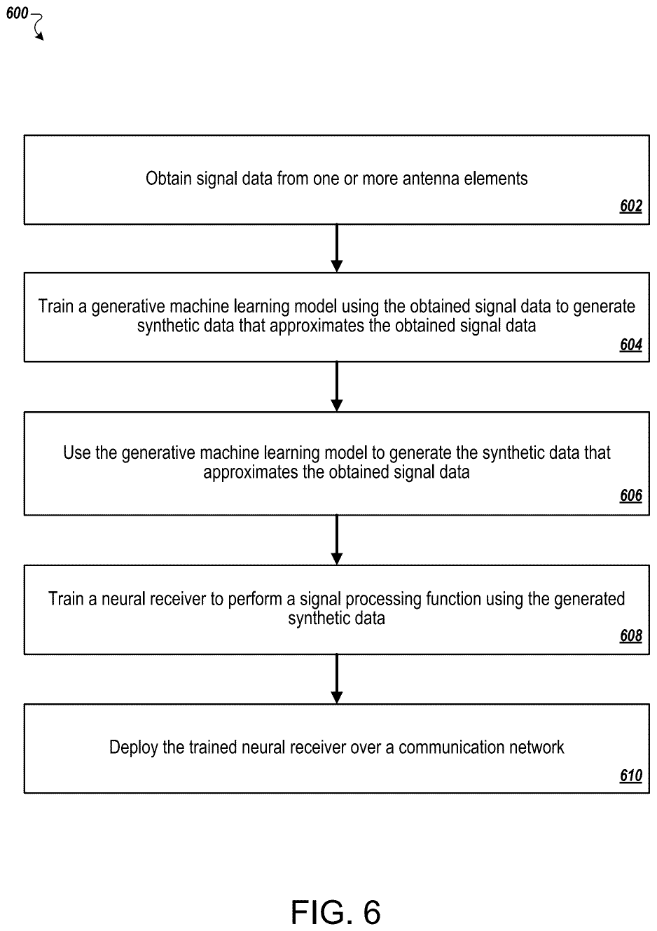

FIG. 6 is a flow chart of an example process for training a generative artificial intelligence model and a neural receiver. For convenience, the process 600 will be described as being performed by a system of one or more computers located in one or more locations. For example, a computer system, e.g., the computer system 108 of FIG. 1, appropriately programmed in accordance with this specification, can perform the process 600.

During 602, the system obtains signal data from one or more antenna elements. The system obtains downlink signal data from one or more antenna elements. The downlink signal data includes orthogonal frequency division multiplexing (OFDM) data. For example, the obtained signal data includes 14 OFDM time slots by 600 pilot resource elements (REs) wide.

During 604, the system trains a generative machine learning model using the obtained signal data to generate synthetic data that approximates the obtained signal data. The generated synthetic data represents a percentage of the obtained signal data while retaining characteristics of the obtained signal data, the percentage being less than an entirety of the obtained signal data. Retaining characteristics of the obtained signal data includes the generated synthetic data retaining a target percentage characteristic of the obtained signal data.

During 606, the system uses the generative machine learning model to generate the synthetic data that approximates the obtained signal data. In some implementations, the generative machine learning model includes a normalizing flow model. The normalizing flow model is configured to (i) generate the synthetic data and (ii) estimate a likelihood that the synthetic data approximates the obtained signal data.

During 608, the system trains a neural receiver to perform a signal processing function using the generated synthetic data. Training the generative machine learning model using the obtained signal data to generate the synthetic data that approximates the obtained signal data includes the system generating a doppler-delay representation of the OFDM data. Additionally, the system trains the generative machine learning model using a subset of coefficients from the doppler-delay representation.

In some implementations, the system can pretrain the neural receiver on 5GNR-compliant PUSCH signals that have passed through a set of TDL channels.

The system can train the generative machine learning model using the obtained signal data to generate the synthetic data that approximates the obtained signal data. In particular, the system generates delay data by applying an inverse discrete Fourier transform along a frequency dimension of the OFDM data. The system generates Doppler data by applying a discrete Fourier transform along a time dimension of the OFDM data. The system generates an output representation of the obtained signal data using the delay data and the Doppler data. The system extracts a subset of coefficients from the output representation of the obtained signal data. In response, the system trains the machine learning model using the extracted subset of coefficients from the output representation.

In some implementations, the system can extract a subset of coefficients from the output representation of the obtained signal data by extracting the subset of coefficients from the output representation by truncating the output representation of the obtained signal around a mean value and a zero Doppler value. In some implementations, the extracted subset of coefficients from the output representation of the obtained signal represents a first target number for doppler bins and a second target number for delay bins. In this case, the first target number is less than the second target number.

In some implementations, the system can train a neural receiver to perform a signal processing function using the generated synthetic data. In particular, the system samples one or more synthetic outputs from the trained generative machine learning model. The system provides the one or more synthetic outputs as input to the neural receiver. In response, the system generates a negative log likelihood using output from the neural receiver. The system updates parameters of the trained neural receiver to perform the signal processing function by minimizing a loss function based on the negative log likelihood. The signal processing function can include, for example, one of demodulation, forward error correction, bit synchronization, timing estimation, or channel estimation. Other examples are also possible.

During 610, the system deploys the trained neural receiver over a communication network. In some implementations, the system deploys the trained neural receiver over a communication network. In particular, the system transmits the trained neural receiver to at least one of a base station, a user equipment device, or a radio.

The term “configured” can be used in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining signal data from one or more antenna elements;
training a generative machine learning model using the obtained signal data to generate synthetic data that approximates the obtained signal data;
using the generative machine learning model to generate the synthetic data that approximates the obtained signal data;
training a neural receiver to perform a signal processing function using the generated synthetic data; and
deploying the trained neural receiver over a communication network.

2. The method of claim 1, wherein the generated synthetic data represents a percentage of the obtained signal data while retaining characteristics of the obtained signal data, the percentage being less than an entirety of the obtained signal data.

3. The method of claim 2, wherein retaining characteristics of the obtained signal data comprises the generated synthetic data retaining a target percentage characteristic of the obtained signal data.

4. The method of claim 1, wherein obtaining signal data from one or more antenna elements comprises obtaining downlink signal data from the one or more antenna elements.

5. The method of claim 4, wherein the downlink signal data comprises orthogonal frequency division multiplexing (OFDM) data.

6. The method of claim 5, wherein training the generative machine learning model using the obtained signal data to generate the synthetic data that approximates the obtained signal data comprises:
generating a doppler-delay representation of the OFDM data; and
training the generative machine learning model using a subset of coefficients from the doppler-delay representation.

7. The method of claim 5, wherein training the generative machine learning model using the obtained signal data to generate the synthetic data that approximates the obtained signal data comprises:
generating delay data by applying an inverse discrete Fourier transform along a frequency dimension of the OFDM data;
generating Doppler data by applying a discrete Fourier transform along a time dimension of the OFDM data;
generating an output representation of the obtained signal data using the delay data and the Doppler data;
extracting a subset of coefficients from the output representation of the obtained signal data; and
training the machine learning model using the extracted subset of coefficients from the output representation.

8. The method of claim 7, wherein extracting a subset of coefficients from the output representation of the obtained signal data comprises extracting the subset of coefficients from the output representation by truncating the output representation of the obtained signal around a mean value and a zero Doppler value.

9. The method of claim 7, wherein the extracted subset of coefficients from the output representation of the obtained signal represents a first target number for doppler bins and a second target number for delay bins, wherein the first target number is less than the second target number.

10. The method of claim 1, wherein training a neural receiver to perform a signal processing function using the generated synthetic data comprises:
sampling one or more synthetic outputs from the trained generative machine learning model;
providing the one or more synthetic outputs as input to the neural receiver;
in response, generating a negative log likelihood using output from the neural receiver; and
updating parameters of the trained neural receiver to perform the signal processing function by minimizing a loss function based on the negative log likelihood.

11. The method of claim 10, wherein the signal processing function comprises at least one of demodulation, forward error correction, bit synchronization, timing estimation, or channel estimation.

12. The method of claim 1, further comprising pretraining the neural receiver on 5GNR-compliant PUSCH signals that have passed through a set of TDL channels.

13. The method of claim 1, wherein the generative machine learning model comprises a normalizing flow model that is configured to (i) generate the synthetic data and (ii) estimate a likelihood that the synthetic data approximates the obtained signal data.

14. The method of claim 1, wherein the obtained signal data comprises 14 OFDM time slots by 600 pilot resource elements (REs) wide.

15. The method of claim 1, wherein deploying the trained neural receiver over a communication network comprises transmitting, over a network, the trained neural receiver to at least one of a base station, a user equipment device, or a radio.

16. A system comprising:
one or more computers and one or more storage devices storing instructions that are operable, when executed by the one or more computers, to cause the one or more computers to perform operations comprising:
obtaining signal data from one or more antenna elements;
training a generative machine learning model using the obtained signal data to generate synthetic data that approximates the obtained signal data;
using the generative machine learning model to generate the synthetic data that approximates the obtained signal data;
training a neural receiver to perform a signal processing function using the generated synthetic data; and
deploying the trained neural receiver over a communication network.

17. The system of claim 16, wherein the generated synthetic data represents a percentage of the obtained signal data while retaining characteristics of the obtained signal data.

18. The system of claim 17, wherein retaining characteristics of the obtained signal data comprises the generated synthetic data retaining a target percentage characteristic of the obtained signal data.

19. The system of claim 16, wherein obtaining signal data from one or more antenna elements comprises obtaining downlink signal data from the one or more antenna elements.

20. A non-transitory computer-readable medium storing software comprising instructions executable by one or more computers which, upon such execution, cause the one or more computers to perform operations comprising:
obtaining signal data from one or more antenna elements;
training a generative machine learning model using the obtained signal data to generate synthetic data that approximates the obtained signal data;
using the generative machine learning model to generate the synthetic data that approximates the obtained signal data;
training a neural receiver to perform a signal processing function using the generated synthetic data; and
deploying the trained neural receiver over a communication network.
